(19) United States
(12) Patent Application Publication
(10) Pub. No.: US 2022/0335920 A1
(43) Pub. Date: Oct. 20, 2022

(54) AUTOMOBILE AND NOISE REDUCTION METHOD THEREOF

(71) Applicant: AAC Microtech (Changzhou) Co., Ltd., Changzhou City (CN)

(72) Inventors: Shuyuan Sun, Shenzhen (CN); Xingzhi Huang, Shenzhen (CN); Hao Yin, Shenzhen (CN); Xudong Yan, Shenzhen (CN)

(21) Appl. No.: 17/555,524

(22) Filed: Dec. 20, 2021

(30) Foreign Application Priority Data
Apr. 9, 2021 (CN) 202110380542.6

(51) Int. Cl. G10K 11/178; G10L 21/0216

(52) U.S. Cl. CPC G10K 11/178; G10L 21/0216; G10K 2210/1282; B60R 11/0247

(57) ABSTRACT

The present disclosure provides an automobile and a noise reduction method thereof, wherein the automobile includes an automobile body having an accommodating space and a plurality of doorways communicating with the accommodating space, a door configured for closing each doorway, at least one seat, at least one sound collecting device mounted on the automobile body at a periphery of each door, at least two sound devices mounted on at least one seat, and a processor electrically connected to all the sound devices and all the sound collecting devices. A noise reduction system composed of all the sound devices, all the sound devices, and the processor can perform noise reduction on a preset area in the accommodating space. The embodiments of the present invention expand and reuse a system composed of original sound collecting devices and sound devices in the automobile, without stacking materials on the doors or the automobile body.

### TECHNICAL FIELD

The present invention relates to the technical field of automobiles, specifically to an automobile and a noise reduction method thereof.

### BACKGROUND

With the rapid development of automotive electronic technologies, a new generation of cockpits can provide customers with better user experience, however, the noise in automobiles has always been a pain point that affects the user's driving experience.

At present, the noise in the automobiles mainly comes from road noise (or referred to as tire noise), engine noise, and wind noise. Existing methods for suppressing the noise in the automobiles are mainly to reduce and block the propagation of the noise by increasing the thickness of glass, adding a sound-absorbing material in an automobile body, and increasing the thickness of a door or the automobile body, so as to achieve a quieter environment in the automobile. However, the existing methods for suppressing the noise in the automobile will stack materials on the door or the automobile body.

Therefore, it is necessary to provide a new automobile noise reduction method to solve the above problems.

### SUMMARY

The present invention aims to provide an automobile and a noise reduction method thereof, there is no materials to be stacked on a door or an automobile body.

The technical solution of the present invention is as follows: an automobile comprises an automobile body having an accommodating space and a plurality of doorways communicating with the accommodating space, at least one seat mounted in the accommodating space, and doors connected with the automobile body and configured for closing each doorway, the automobile further comprises at least one sound collecting device mounted on the automobile body at a periphery of each door, at least two sound devices mounted on the at least one seat, and a processor electrically connected to all the sound devices and all the sound collecting devices, each sound collecting device is configured for collecting a first noise signal corresponding to each door; the accommodating space inside has at least two preset positions spaced from the seat; the processor generates, on the basis of each first noise signal, a noise reduction signal transmitted to each sound device; and each sound device is configured for sending, according to the noise reduction signal, a sound signal to the at least two preset positions to offset all second noise signals transmitted from each door to the at least two preset positions.

Preferably, each sound collecting device is mounted in the accommodating space and is located above each corresponding door.

Preferably, the seat comprises a seat body and a headrest arranged at a top of the seat body, and two of the at least two sound devices are arranged on the headrest.

Preferably, the processor is configured for:

calculating and obtaining, according to the first noise signal at each door and a first function from the first noise signal to one of the preset positions, a processed signal from the door to the preset position;

calculating and obtaining, according to each processed signal, an acoustic response of each sound device, and a second function from each sound device to one of the preset positions, the noise reduction signal sent from the sound device to one of the preset positions.

Preferably, the first function and the second function are both acoustic transmission functions related to frequency, amplitude, phase, and delay time.

Preferably, four doors are provided, and four sound collecting devices are provided; wherein one sound collecting device is arranged at one corresponding door; the seat comprises a seat body and a headrest; one headrest is provided with two sound devices at an interval; the automobile body inside has two preset positions spaced from the headrest; the processor generates, on the basis of the four first noise signals, one noise reduction signal transmitted to each sound device; and each sound device is configured for sending, according to the noise reduction signal, the sound signal to the two preset positions to offset eight second noise signals transmitted from each door to the two preset positions.

Preferably, the sound collecting device is an electret microphone or micro microphones; and the sound device is a moving-coil type, piezoelectric type or electrostatic mini speaker.

The present invention further provides a noise reduction method for an automobile, wherein the automobile comprises an automobile body having an accommodating space and a plurality of doorways communicating with the accommodating space, at least one seat mounted in the accommodating space, and a door connected with the automobile body and configured for closing each doorway, the automobile body inside has at least two preset positions spaced from the seat, and the noise reduction method comprises:

acquiring a first noise signal which is collected by a sound collecting device arranged on the automobile body at a periphery of each door and corresponds to the door;

processing each first noise signal to obtain a noise reduction signal transmitted to each of at least two sound devices arranged on each seat;

controlling each sound device to send, according to the noise reduction signal, a sound signal to the at least two preset positions to offset all second noise signals from each door to the at least two preset positions.

Preferably, the processing each first noise signal to obtain a processed signal of each preset position in the at least two preset positions spaced from the seat comprises:

calculating and obtaining, according to the first noise signal at each door and a first function from the first noise signal to one of the preset positions, a processed signal from the door to each preset position; and

calculating and obtaining, according to each processed signal, an acoustic response of each sound device, and a second function from each sound device to one of the preset positions, the noise reduction signal sent from each sound device to one of the preset positions.

Preferably, the value of the noise reduction signal of each preset position is equal to a value of all the second noise signals transmitted from the door to the preset position.

The present invention has the beneficial effects: compared with the existing art, the present invention expands and reuses a system composed of original sound collecting devices and sound devices in the automobile, without stacking materials on the doors or the automobile body.

In addition, in the present invention, the sound collecting devices are arranged on the automobile body, and the sound devices are arranged on the seats. Accordingly, separate mounting of the sound collecting devices and the sound devices can prevent howling and also can reduce the influence of the noise reduction signals sent by the sound devices on collection of the noise signals by the sound collecting devices.

### BRIEF DESCRIPTION OF THE DRAWINGS

FIG. 1 is a first schematic structural diagram of an automobile provided by the present invention;

FIG. 2 is a second schematic structural diagram of an automobile provided by the present invention;

FIG. 3 is a schematic diagram of a scenario in which a sound collecting device in the automobile shown in FIG. 1 collects a signal;

FIG. 4 is a schematic diagram of a scenario in which a sound device in the automobile shown in FIG. 1 sends a signal;

FIG. 5 is a schematic diagram of a scenario of a method for measuring a first function provided by the present invention;

FIG. 6 is a schematic diagram of a scenario of a method for measuring a second function provided by the present invention;

FIG. 7 is a first flowchart of a noise reduction method for an automobile provided by the present invention; and

FIG. 8 is a second flowchart of a noise reduction method for an automobile provided by the present invention.

### DETAILED DESCRIPTION OF THE EMBODIMENTS

The present invention is further described below in combination with the accompanying drawings and embodiments.

The embodiments of the present invention provide an automobile and a noise reduction method thereof. In particular, the automobile includes an automobile body having an accommodating space and a plurality of doorways communicating with the accommodating space, at least one seat mounted in the accommodating space, and a door connected with the automobile body and configured for closing each doorway. For example, the automobile can be referred as a truck, an ordinary car, a sports car, and the like. The sports car may be provided with one seat and one door, of course, the sports car may also be provided with more seats and more doors, and this is only exemplified and shall not be understood as a limitation to the sports car. In another example, the ordinary car may be provided with four doors and four seats, and the truck may be provided with two seats and two doors. During use of an automobile, the auditory feeling of a driver will be affected by road noise, engine noise, wind noise, and other noise in the automobile, and normal driving of the driver may be possibly affected by too much noise. Therefore, the noise transmitted from the outside to the inside of the automobile needs to be processed.

The automobile provided by the embodiments of the present invention further includes at least one sound collecting device mounted on the automobile body at a periphery of each door, at least two sound devices mounted on the at least one seat, and a processor electrically connected to all the sound devices and all the sound collecting devices. In particular, each sound collecting device is configured for collecting a first noise signal corresponding to each door; the accommodating space inside has at least two preset positions spaced from the seat; the processor generates, on the basis of each first noise signal, a noise reduction signal transmitted to each sound device; and each sound device is configured for sending, according to the noise reduction signal, a sound signal to the at least two preset positions to offset all second noise signals transmitted from each door to the at least two preset positions. Compared with the existing art, the embodiments of the present invention expand and reuse a system composed of original sound collecting devices and sound devices in the automobile, without stacking materials on the doors or the automobile body. In addition, in the embodiments of the present invention, the sound collecting devices are arranged on the automobile body, and the sound devices are arranged on the seats. In this way, the sound collecting devices and the sound devices are separately mounted, which can prevent howling and also can reduce the influence of the noise reduction signals sent by the sound devices on the noise signals collected by the sound collecting devices.

In particular, “at least one” may refer to one or more, and “at least two” is two or more. That is, the automobile may have one or more doors, and one or more seats. For the convenience of description, the embodiments of the present invention are specifically described below by taking an automobile with four doors and four seats and a state that all doors are closed as an example below.

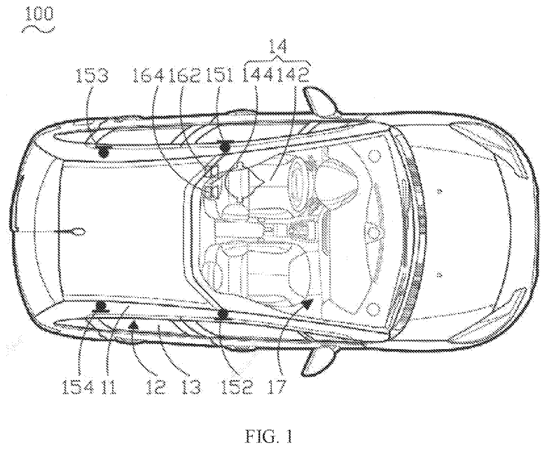

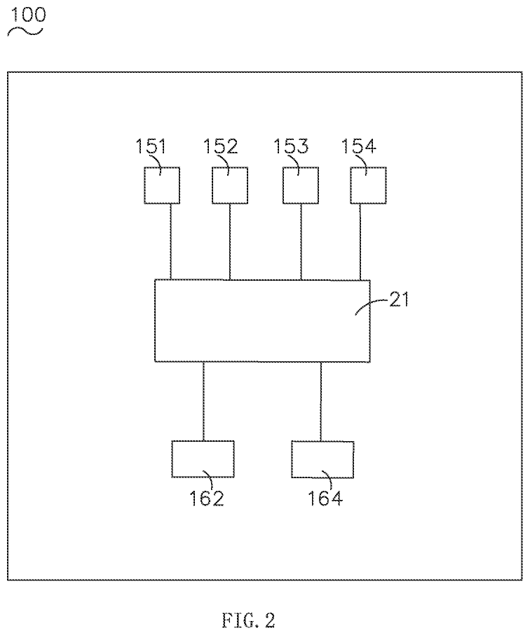

Referring to FIG. 1 and FIG. 2, FIG. 1 is a first schematic structural diagram of an automobile provided by the present invention, and FIG. 2 is a second schematic structural diagram of an automobile provided by the present invention. One embodiment of the present invention provides an automobile 100 including an automobile body 11, four seats 14, and four doors 13. The automobile body 11 has an accommodating space 17 and four doorways 12 communicating with the accommodating space 17, wherein the four doors 13 are configured for closing the four doorways 12, that is, one door 13 correspondingly closes one doorway 12. The four seats 14 are mounted in the accommodating space 17. It can be appreciated that the four seats 14 are arranged in two rows and two columns, and each door 13 is close to one seat 14.

In particular, the automobile 100 further includes a first sound collecting device 151, a second sound collecting device 152, a third sound collecting device 153, and a fourth sound collecting device 154 which are mounted on the automobile body 11 at a periphery of each door 13. Each sound collecting device is arranged above the door 13 and is located on the automobile body 11 of the accommodating space 17. It should be noted that each sound collecting device may be placed at a hand grab position of a ceiling right above each door 13. This position is a first position where wind noise outside the automobile is transmitted to the inside the automobile, that is, a noise source position of the wind noise in the automobile. This is favorable for more accurately catching noise information and excluding the influence of other sounds on target noise picked up by the sound collecting devices, thus improving the signal-to-noise ratio of the noise collected by the sound collecting devices.

In particular, the first sound collecting device 151, the second sound collecting device 152, the third sound collecting device 153, and the fourth sound collecting device 154 can all use, but not limited to, electret microphones and Micro Electro Mechanical System (MEMS) microphones.

In particular, the automobile 100 further includes a first sound device 162 and a second sound device 164 which are mounted on one seat 14. As shown in FIG. 1, the first sound device 162 and the second sound device 164 are arranged on a main driving position to perform noise reduction on the main driving position. Each seat 14 includes a seat body 142 and a headrest 144 disposed at the top of the seat body 142. The first sound device 162 and the second sound device 164 may be spaced apart from the headrest 144 disposed at the top of the seat body 142. It should be noted that if there are multiple seats 14, each seat 14 may be provided with a first sound device 162 and a second sound device 164, or only one or part of the seats 14 may be provided with the first sound device. 162 and the second sound device 164. When the first sound device 162 and the second sound device 164 are provided at only one seat position, the position may be the main driving position. In addition, one seat 14 can be provided with at least two sound devices, that is, at least including a first sound device 162 and a second sound device 164, and one seat 14 can be selected to be provided with a first sound device 162 and a second sound device 164. Compared with a situation where multiple sound devices are provided on one seat 14, two sound devices, namely the first sound device 162 and the second sound device 164, can achieve a noise reduction effect without wasting resources, and the cost performance is relatively high.

It should be noted that arranging the first sound device 162 and the second sound device 164 at the position of the headrest 144 can make the first sound device 162 and the second sound device 164 closer to an area that needs noise reduction and can reduce the loss of sound signals emitted by the first sound device 162 and the second sound device 164 during propagation.

In particular, both the first sound device 162 and the second sound device 164 can be a speaker monomer or a speaker module, the core monomer of the speaker can use a micro speaker, and the micro speaker can be, but not limited to, a moving-coil type, piezoelectric type and electrostatic type speaker.

The automobile 100 further includes a processor 21 for data processing. The processor 21 is electrically connected to the first sound collecting device 151, the second sound collecting device 152, the third sound collecting device 153, the fourth sound collecting device 154, the first sound device 162, and the second sound device 164, respectively, so that the processor 21 can receive processed signals of the first sound collecting device 151, the second sound collecting device 152, the third sound collecting device 153, and the fourth sound collecting device 154 and send noise reduction signals to the first sound device 162 and the second sound device 164. Each sound collecting device is configured for collecting a first noise signal at the corresponding door 13; and the processor 21 generates a noise reduction signal on the basis of the first noise signal; and the sound device is configured for sending, according to the noise reduction signal, a sound signal to offset a second noise signal.

The accommodating space 17 inside has at least two preset positions spaced from the seat 14. It should be appreciated that the automobile 100 is provided with a preset area and at least two preset positions disposed in the preset area inside. Exemplarily, the accommodating space 17 inside has a first preset position 182 and a second preset position 184 which are spaced from the seat 14. The preset area is an area that needs noise reduction. More specifically, it may correspond to the head position of a person (such as the driver) sitting on the seat. The two preset positions can be understood as corresponding to two ear positions of the head. It can be understood that the two ear positions of the driver in the driving position are positions needing noise reduction. Therefore, the first preset position 182 may correspond to the left ear of the driver, and the second preset position 184 may correspond to the right ear of the driver. Correspondingly, the first sound device 162 and the first preset position 182 can be correspondingly arranged on the headrest 144, and the second sound device 164 and the second preset position 184 can be correspondingly arranged on the headrest 144 and spaced from the first sound device 162. In addition, the first sound collecting device 151 and the third sound collecting device 153 are arranged on the left side of the first preset position 182 in a spacing manner; the second sound collecting device 152 and the fourth sound collecting device 154 are spaced from each other and opposite to the first sound collecting device 151 and the third sound collecting device 153 and are located on the right side of the second preset position 184. The first sound collecting device 151 is closer to the first preset position 182 than the third sound collecting device 153, and the second sound collecting device 152 is closer to the second preset position 184 than the fourth sound collecting device 154.

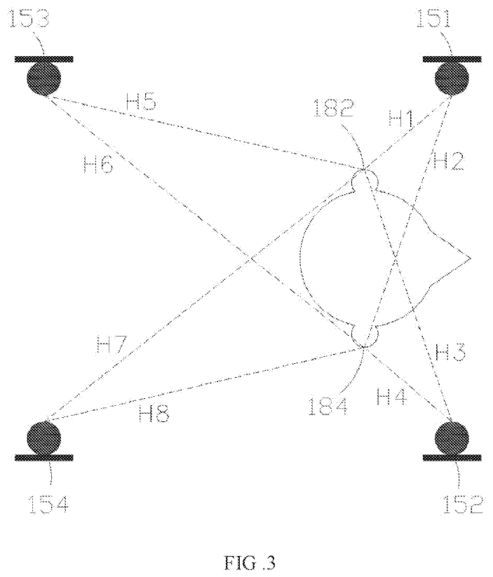

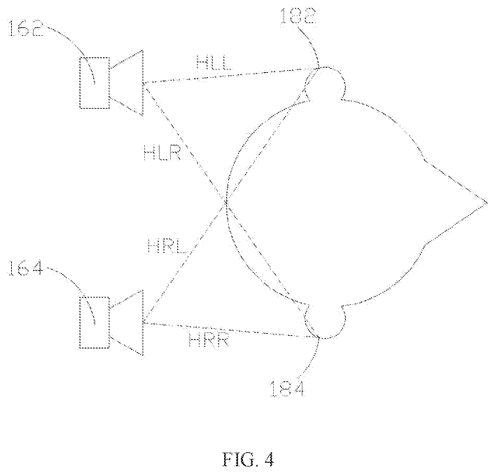

In order to more clearly explain signal collection and sending scenarios at the two preset positions, the following descriptions are made with reference to FIG. 3 and FIG. 4, respectively. FIG. 3 is a schematic diagram of a scenario in which a sound collecting device in the automobile shown in FIG. 1 collects a signal, and FIG. 4 is a schematic diagram of a scenario in which a sound device in the automobile shown in FIG. 1 sends a signal.

The processor 21 is configured for calculating and obtaining (according to the first noise signal at each door and a first function from the first noise signal to one preset position) a processed signal from the door to the preset position; calculating and obtaining, according to each processed signal, an acoustic response of each sound device, and a second function from each sound device to one preset position, the noise reduction signal sent from each sound device to one preset position.

In particular, the first function and the second function are both acoustic transmission functions related to frequency, amplitude, phase, and delay time. It should be noted that the acoustic transmission function represents that when a sound is transmitted from one position to another position, a change in an original sound source is a function related to frequency, amplitude, phase, and delay and may be expressed as the following form:

H=h(f,gain,Φ,t)

wherein f denotes the frequency of a sound;

gain denotes the amplitude of the sound;

Φ denotes the phase of the sound;

t denotes the delay of the sound.

For example, the processor 21 obtains the processed signal on the basis of multiplying the first noise signal collected by the first sound collecting device 151 with the acoustic transmission function H1 from the position of the first sound collecting device 151 to the first preset position 182. It can be understood that due to a calculation error, the processed signal is approximately equal to the second noise signal directly transmitted from the first sound collecting device 151 to the first preset position 182. The processor 21 obtains the processed signal on the basis of multiplying the first noise signal collected by the first sound collecting device 151 with the acoustic transmission function H2 from the position of the first sound collecting device 151 to the second preset position 184. Similarly, the processed signal is approximately equal to the second noise signal directly transmitted from the first sound collecting device 151 to the second preset position 184.

The processor 21 obtains the processed signal on the basis of multiplying the first noise signal collected by the second sound collecting device 152 with the acoustic transmission function H3 from the position of the second sound collecting device 152 to the first preset position 182. The processed signal is approximately equal to the second noise signal directly transmitted from the second sound collecting device 152 to the first preset position 182. The processor 21 obtains the processed signal on the basis of multiplying the first noise signal collected by the second sound collecting device 152 with the acoustic transmission function H4 from the position of the second sound collecting device 152 to the second preset position 184. The processed signal is approximately equal to the second noise signal directly transmitted from the second sound collecting device 152 to the second preset position 184.

The processor 21 obtains the processed signal on the basis of multiplying the first noise signal collected by the third sound collecting device 153 with the acoustic transmission function H5 from the position of the third sound collecting device 153 to the first preset position 182. The processed signal is approximately equal to the second noise signal directly transmitted from the third sound collecting device 153 to the first preset position 182. The processor 21 obtains the processed signal on the basis of multiplying the first noise signal collected by the third sound collecting device 153 with the acoustic transmission function H6 from the position of the third sound collecting device 153 to the second preset position 184. The processed signal is approximately equal to the second noise signal directly transmitted from the third sound collecting device 153 to the second preset position 184.

The processor 21 obtains the processed signal on the basis of multiplying the first noise signal collected by the fourth sound collecting device 154 with the acoustic transmission function H7 from the position of the fourth sound collecting device 154 to the first preset position 182. The processed signal is approximately equal to the second noise signal directly transmitted from the fourth sound collecting device 154 to the first preset position 182. The processor 21 obtains the processed signal on the basis of multiplying the first noise signal collected by the fourth sound collecting device 154 with the acoustic transmission function H8 from the position of the fourth sound collecting device 154 to the second preset position 184. The processed signal is approximately equal to the second noise signal directly transmitted from the fourth sound collecting device 154 to the second preset position 184.

It should be noted that the first noise signal can be understood as a noise signal corresponding to the door, and the second noise signal can be understood as a noise signal transmitted from the door or the outside of the automobile to a preset position. Since the second noise signal of the preset position is not easy to obtain, the processed signal calculated and obtained by the processor 21 on the basis of the first noise signal and the acoustic transmission function from the first noise signal to the preset position is regarded as the second noise signal, and a noise reduction signal needing to be transmitted to a sound device is calculated according to the processed signal.

Wind noise used as the first noise signal is taken as an example for illustration.

It can be appreciated that when wind noise signals, i.e., the first noise signals, received by the first sound collecting device 151, the second sound collecting device 152, the third sound collecting device 153, and the fourth sound collecting device 154 are respectively N1, N2, N3, and N4, the actual wind noise transmitted to the first preset position 182 is:

N1*H1+N2*H3+N3*H5+N4*H7

wherein * denotes convolution operation.

It is written into a matrix form:

[N1N2N3N4]·[H1H3H5H7]^{T}

Similarly, actual wind noise transmitted to the second preset position 184 is:

[N1N2N3N4]·[H2H4H6H8]^{T}

where denotes multiplication of two matrixes;

N1 denotes the wind noise signal, i.e., the first noise signal, received by the first sound collecting device 151;

N2 denotes the wind noise signal, i.e., the first noise signal, received by the second sound collecting device 152;

N3 denotes the wind noise signal, i.e., the first noise signal, received by the third sound collecting device 153;

N4 denotes the wind noise signal, i.e., the first noise signal, received by the fourth sound collecting device 154;

H1 denotes the acoustic transmission function from the first sound collecting device 151 to the first preset position 182;

H2 denotes the acoustic transmission function from the first sound collecting device 151 to the second preset position 184;

H3 denotes the acoustic transmission function from the second sound collecting device 152 to the first preset position 182;

H4 denotes the acoustic transmission function from the second sound collecting device 152 to the second preset position 184;

H5 denotes the acoustic transmission function from the third sound collecting device 153 to the first preset position 182;

H6 denotes the acoustic transmission function from the third sound collecting device 153 to the second preset position 184;

H7 denotes the acoustic transmission function from the fourth sound collecting device 154 to the first preset position 182;

H8 denotes the acoustic transmission function from the fourth sound collecting device 154 to the second preset position 184.

The first function can be understood as any one of the acoustic transmission functions from H1 to H8. H1 to H8 may be obtained by actual measurement.

It can be appreciated that there are four different second noise signals in total at the first preset position 182, and there are also four different second noise signals at the second preset position 184. The processor 21 generates, on the basis of the four first noise signals, one noise reduction signal transmitted to each sound device. Each sound device is configured for sending, according to the noise reduction signal, a sound signal to the two preset positions to offset the eight second noise signals transmitted from each door to the two preset positions. The first preset position 182 correspondingly has four processed signals, and the second preset position 184 also has four processed signals. The processor 21 generates, according to the eight processed signals, two noise reduction signals transmitted to the first sound device 162 and the second sound device 164. The two noise reduction signals are configured for offsetting the eight second noise signals of the first preset position 182 and the second preset position 184.

The first sound device 162 and the second sound device 164 need to send corresponding sound signals to offset the actual wind noise, i.e., the second noise signals, of the preset positions. If the processed signal fed to the first sound device 162 is L, and the processed signal fed to the second sound device 164 is R, the sound signals, transmitted to the first preset position 182, of sounds produced by the sound devices may be expressed as:

R*SPK_{Right}*HRL+L*SPK_{Left}*HLL

wherein * denotes convolution operation.

It is written into a matrix form:

$$[ \begin{matrix}R & L\end{matrix} ] \cdot [ \begin{matrix}{SPK}_{Right} & 0 \\ 0 & {SPK}_{Left}\end{matrix} ] \cdot [ \begin{matrix}HRL & {HLL ]}^{T}\end{matrix}$$

where * denotes the multiplication of matrixes;

HRL denotes the acoustic transmission function from the second sound device 164 to the first preset position 182;

HLL denotes the acoustic transmission function from the first sound device 162 to the first preset position 182;

SPK_{Left} denotes an acoustic response of the first sound device;

SPK_{Right} denotes an acoustic response of the second sound device;

wherein SPK_{Left} and SPK_{Right} may be both obtained by actual measurement.

Similarly, the sound signals, transmitted to the second preset position 184, of sounds produced by the sound devices are:

$$[ \begin{matrix}R & L\end{matrix} ] \cdot [ \begin{matrix}{SPK}_{Right} & 0 \\ 0 & {SPK}_{Left}\end{matrix} ] \cdot {[ \begin{matrix}HRL & HLL\end{matrix} ]}^{T}$$

wherein · denotes the multiplication of matrixes;

HRR denotes the acoustic transmission function from the second sound device 164 to the second preset position 184;

HLR denotes the acoustic transmission function from the first sound device 162 to the second preset position 184.

The second function may be understood as the four acoustic transmission functions HLL, HLR, HRL, and HRR, and HLL, HLR, HRL, and HRR may be all obtained by actual measurement.

When the processed signal L fed to the first sound device 162 and the processed signal R fed to the second sound device 164 satisfy the following conditions, it can be considered that the sound device disposed at the position of the headrest achieves the optimal effect of noise reduction.

$$\vert [ \begin{matrix}N 1 & N 2 & N 3 & N 4 ] \cdot [ H 1 & H 3 & H 5 & {H 7 ]}^{T} +\end{matrix} \begin{matrix}[ \begin{matrix}R & L\end{matrix} ] \cdot [ \begin{matrix}{SPK}_{Right} & 0 \\ 0 & {SPK}_{Left}\end{matrix} ] \cdot [ HRL & {HLL ]}^{T} \vert = 0\end{matrix}$$

$$\vert \begin{matrix}[ N 1 & N 2 & N 3 & N 4 ] \cdot [ H 2 & H 4 & H 6 & {H 8 ]}^{T}\end{matrix} + [ \begin{matrix}R & L ] \cdot [ \begin{matrix}{SPK}_{Right} & 0 \\ 0 & {SPK}_{Left}\end{matrix} ] \cdot [ HRR & {HLR ]}^{T} \vert = 0\end{matrix}$$

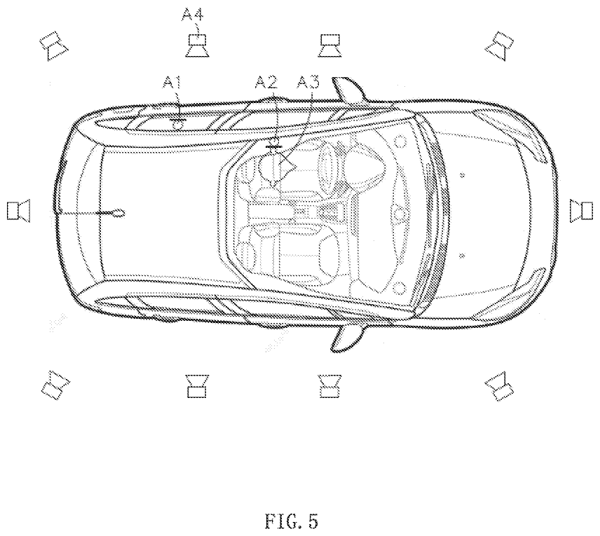

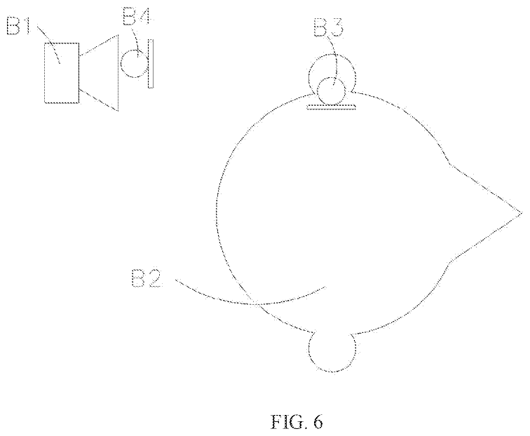

In particular, the first function and the second function may be obtained by actual measurement. For example, referring to FIG. 5 and FIG. 6, FIG. 5 is a schematic diagram of a scenario of a method for measuring a first function provided by the present invention, and FIG. 6 is a schematic diagram of a scenario of a method for measuring a second function provided by the present invention.

Referring to FIG. 3 and FIG. 5 in combination, H1 to H8 are the acoustic transmission functions. The first function may be understood as any one of the acoustic transmission functions from H1 to H8. A method for measuring the acoustic transmission function H5 from the third sound collecting device 153 to the first preset position 182 is taken as an example for illustration. The method for measuring the acoustic transmission function H1, the method for measuring the acoustic transmission function H2, the method for measuring the acoustic transmission function H3, the method for measuring the acoustic transmission function H4, the method for measuring the acoustic transmission function H6, the method for measuring the acoustic transmission function H7, and the method for measuring the acoustic transmission function H8 may refer to the method for measuring the acoustic transmission function H5, and descriptions thereof are omitted here.

In particular, devices related to the measurement method include a sound collecting device A1 mounted on a door 13, an artificial head and body simulator A3 placed at a main driving position, a built-in sound collecting device A2 of the artificial head and body simulator A3, and a sound device A4 configured for simulating external noise. Exemplarily, both the sound collecting device A1 and the sound collecting device A2 may be microphones. They may use, but are not limited to, electret microphones and MEMS microphones. The artificial head and body simulator A3 may use, but is not limited to, B&K TYPE 4128C. The sound device A4 can be a speaker monomer or a speaker module. A core monomer of the speaker can use a micro speaker. The micro speaker can be, but not limited to, a moving-coil type, piezoelectric type and electrostatic type speaker. A plurality of sound devices A4 may be uniformly placed around the automobile to be tested 100 in one circle. Preferably, the number of the plurality of sound devices A4 can be any one from 8 to 12. For example, eight sound devices A4 are uniformly placed around the automobile to be tested 100 in one circle. Four sound devices A4 are placed on each of two sides of the automobile to be tested 100. One sound device A4 is placed on each of the front end and the rear end of the automobile to be tested 100.

The plurality of sound devices A4 uniformly arranged at the automobile to be tested 100 are configured for simultaneously playing noise signals. The noise signals include, but are not limited to, a pink noise signal, a white noise signal, and an analog program signal. The above noise signals can also be customized according to actual needs. The sound signals collected by the sound collecting device A1 and the sound collecting device A2 are respectively S1 and S2, and the acoustic transmission function H5 may be calculated by the following formula:

H5=S2/S1

Referring to FIG. 4 and FIG. 6 in combination, HLL, HLR, HRL, and HRR are all acoustic transmission functions, and the second function can be understood as any one of the acoustic transmission functions HLL, HLR, HRL, and HRR. The method for measuring the acoustic transmission function HLL from the first sound device 162 to the first preset position 182 is taken as an example for description. The method for measuring the acoustic transmission function HRL from the second sound device 164 to the first preset position 182, the method for measuring the acoustic transmission function HRR from the second sound device 164 to the second preset position 184, and the method for measuring the acoustic transmission function HLR from the first sound device 162 to the second preset position 184 may refer to the method for measuring the acoustic transmission function HLL, and descriptions thereof are omitted here.

Devices related to the measurement method include a sound device B1 mounted on the left side of the headrest 144, an artificial head and body simulator B2 placed at the main driving position, a built-in sound collecting device B3 of the artificial head and body simulator B2, and a sound collected device B4 placed at a sound outlet position of the sound device B1. The sound device B1 can be a speaker monomer or a speaker module. A core monomer of the speaker can use a micro speaker. The micro speaker can be, but not limited to, a moving-coil type, piezoelectric type and electrostatic type speaker. The artificial head and body simulator B2 may use, but is not limited to, B&K TYPE 4128C. Both the sound collecting device B3 and the sound collecting device B4 may be microphones. They may use, but are not limited to, electret microphones and MEMS microphones.

The sound devices B1 is configured for playing noise signals. The noise signals include, but are not limited to, a pink noise signal, a white noise signal, and an analog program signal. The above noise signals can also be customized according to actual needs. The sound signals collected by the sound collecting device B3 and the sound collecting device B4 are respectively S3 and S4, and the acoustic transmission function HLL may be calculated by the following formula:

HLL=S3/S4

The embodiments of the present invention expand and reuse a system composed of original sound collecting devices and sound devices in the automobile, without stacking materials on the doors or the automobile body. The sound collecting devices are placed at the noise source positions, which can improve the signal-to-noise ratio of noise collection. The sound device at the headrest of the seat is used to reduce the noise, which can reduce the loss of an active offset signal in a propagation process and enhance the noise reduction effect. In the embodiments of the present invention, the sound collecting devices are arranged on the automobile body, and the sound devices are arranged on the headrests. In this way, the sound collecting devices and the sound devices are separately mounted, which can prevent howling and also can reduce the influence of the noise reduction signals sent by the sound devices on the noise signals collected by the sound collecting devices.

For more clearly describe the specific modes for automobile noise reduction in the present invention, a noise reduction method for an automobile will be described below.

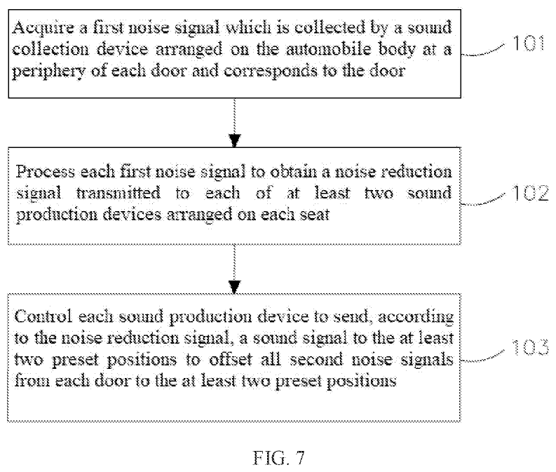

Referring to FIG. 7, FIG. 7 is a first flowchart of a noise reduction method for an automobile provided by the present invention. The embodiments of the present invention provide a noise reduction method for an automobile. The automobile includes an automobile body having an accommodating space and a plurality of doorways communicating with the accommodating space, at least one seat mounted in the accommodating space, and a door connected with the automobile body and configured for closing each doorway. The automobile body inside has at least two preset positions spaced from the seat. The structure of the automobile may refer to FIG. 1, and descriptions thereof are omitted here. The noise reduction method for an automobile includes the following steps:

101. A first noise signal which is collected by a sound collecting device arranged on an automobile body at a periphery of each door and corresponds to the door.

The sound collecting device is configured for collecting noise from the position of a noise source, such as wind noise. Since the hand grab position right above each door in the automobile is where the wind noise firstly enters the automobile or is where the wind noise volume is the largest, the sound collecting device may be disposed at the hand grab position right above each door. The sound collecting devices are placed at the hand grab positions, which can improve the signal-to-noise ratio of noise receiving.

For example, the automobile includes four doors, and one sound collecting device is correspondingly arranged at a periphery of each door. Each sound collecting device collects a first noise signal at the corresponding door, and four first noise signals in total are collected.

102. Each first noise signal is processed to obtain a noise reduction signal transmitted to each of at least two sound devices arranged on each seat.

Since noise reduction needs to be performed on a preset area in the automobile, such as a head area of the driver, two preset positions in the accommodating space of the automobile may be specifically involved. One preset position can correspond to the left ear of the driver, and the other preset position can correspond to the right ear of the driver. For the noise reduction of the two preset positions, noise signals of the preset positions need to be calculated, and noise reduction signals that lower or eliminate noise signals are sent according to the noise signals. Since the noise signal of the preset position is not easy to obtain, the noise signal of the preset position can be calculated according to the first noise signal and can be regarded as an actual noise signal transmitted from the door or the outside of the automobile to the preset position.

103. Each sound device is controlled to send, according to the noise reduction signal, a sound signal to the at least two preset positions to offset all second noise signals from each door to the at least two preset positions.

The noise reduction signal is sent to each sound device, and the sound device is controlled to send the sound signal to offset all the noise signals of the at least two preset positions. For example, the headrest of one seat is provided with two sound devices that are spaced and there are two preset positions in the accommodating space. If the first sound device corresponds to the first preset position, and the second sound device corresponds to the second preset position, the two sound devices send the sound signals to offset all the second noise signals of the two preset positions. The first sound device may send the sound signal according to a processed signal calculated and obtained by the first noise signal and a first function, an acoustic response of the first sound device, and the noise reduction signal obtained by a second function from the first sound device to the first preset position and a second function from the first sound device to the second preset position. The second sound device may send the sound signal according to a processed signal calculated and obtained by the first noise signal and the first function, an acoustic response of the second sound device, and the noise reduction signal obtained by a second function from the second sound device to the first preset position and a second function from the second sound device to the second preset position.

It should be noted that the first function and the second function are both acoustic transmission functions related to frequency, amplitude, phase, and delay time.

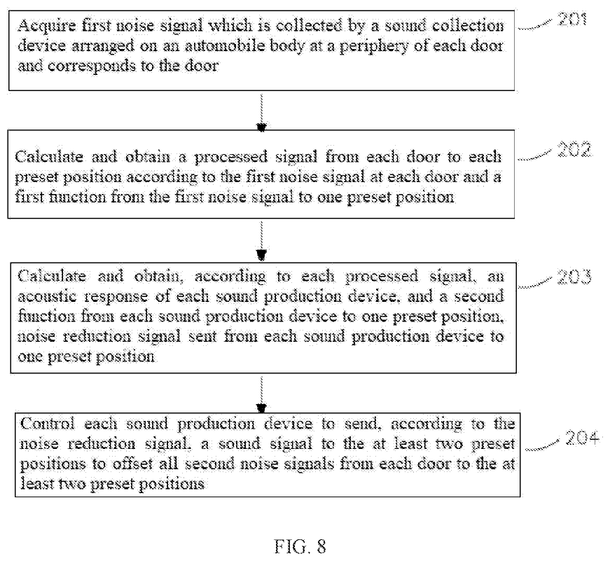

The noise reduction method for the automobile according to the embodiments of the present invention is not limited to the above steps. Exemplarily, referring to FIG. 8, FIG. 8 is a second flowchart of a noise reduction method for an automobile provided by the present invention. The noise reduction method for an automobile includes:

201. A first noise signal which is collected by a sound collecting device arranged on an automobile body at a periphery of each door and corresponds to the door.

This may specifically refer to the step 101, and the descriptions thereof will be omitted.

202. A processed signal from each door to each preset position is calculated and obtained according to the first noise signal at each door and a first function from the first noise signal to one preset position.

Exemplarily, the automobile includes four doors, and the accommodating space of the automobile inside has two preset positions. One sound collecting device is correspondingly arranged at a periphery of each door. The processed signal from this door to this preset position is calculated and obtained according to the first noise signal at one door and the first function from the first noise signal to one preset position. Each preset position corresponds to four processed signals. Since the actual noise signal of the preset position are hard to acquire, the processed signal may be used as the actual noise signal transmitted from the door to the preset position. The first function is an acoustic transmission function related to frequency, amplitude, phase, and delay time.

203. A noise reduction signal sent from each sound device to one preset position is calculated and obtained according to each processed signal, an acoustic response of each sound device, and a second function from each sound device to one preset position.

Since the noise signal of the preset position needs to be reduced, noise information of the preset position needs to be obtained at first, and a noise reduction signal is sent according to the noise information to lower or eliminate the noise signal of the preset position. Exemplarily, the accommodating space of the automobile inside has two preset positions. Two sound devices are arranged at the headrest position of one seat, and one sound device corresponds to one preset position so that the sound device can eliminate the noise of the preset position in a targeted manner. One sound device receives one noise reduction signal. One noise reduction signal received by one sound device is calculated and obtained according to all the processed signals, the acoustic response of one sound device, and the second function from the sound device to one preset position. The second function is an acoustic transmission function related to frequency, amplitude, phase, and delay time.

204. Each sound device is controlled to send, according to the noise reduction signal, a sound signal to the at least two preset positions to offset all second noise signals from each door to the at least two preset positions.

This may specifically refer to the step 103, and the descriptions thereof will be omitted.

A value of the noise reduction signal of each preset position is equal to a value of all the second noise signals transmitted from the door to the preset position. It can be understood that when this condition is satisfied, the noise reduction effect of the preset area in the accommodating space of the automobile is the best.

Compared with the existing art, in the automobile and the noise reduction method for the automobile according to the embodiments of the present invention, the sound collecting devices are placed at the position of the noise source, which can improve the signal-to-noise ratio of noise collection. The sound device at the headrest of the seat is used to reduce the noise, which can reduce the loss of an active offset signal in a propagation process and enhance the noise reduction effect. Separate mounting of the sound collecting devices and the sound devices can prevent howling and can also reduce the influence of signals for active noise reduction sent by the sound devices on collection of the noise signals by the sound collecting devices. A system composed of original sound collecting devices and sound devices in the automobile is expanded and reused, without stacking materials on the doors or the automobile body.

In the description of the present invention, the terms “first” and “second” are only for the purpose of description, and may not be understood as indicating or implying the relative importance or impliedly indicating the number of technical features indicated. Therefore, features defined by “first” and “second” can explicitly instruct or impliedly include one or more features.

The embodiments of the present invention are described above only. It should be noted that those of ordinary skill in the art can further make improvements without departing from the concept of the present invention. These improvements shall all fall within the protection scope of the present invention.

What is claimed is:

1. An automobile comprising an automobile body having an accommodating space and a plurality of doorways communicating therewith, at least one seat mounted in the accommodating space, and doors connected with the automobile body and configured for closing each doorway,
wherein the automobile further comprises at least one sound collecting device mounted on the automobile body at a periphery of each door, at least two sound devices mounted on the at least one seat, and a processor electrically connected to all the sound devices and all the sound collecting devices;
each of the sound collecting devices collecting device is configured for collecting a first noise signal corresponding to each door; the accommodating space inside has at least two preset positions spaced from the seat; the processor generates, on the basis of each first noise signal, a noise reduction signal transmitted to each of the sound devices; and each of the sound devices is configured for sending, according to the noise reduction signal, a sound signal to the at least two preset positions to offset all second noise signals transmitted from each door to the at least two preset positions.

2. The automobile of claim 1, wherein each sound collecting device is mounted in the accommodating space and is located above each corresponding door.

3. The automobile of claim 1, wherein the seat comprises a seat body and a headrest arranged at a top of the seat body, and there are two sound devices are arranged on the headrest.

4. The automobile of claim 2, wherein the seat comprises a seat body and a headrest arranged at a top of the seat body, and there are two sound devices are arranged on the headrest.

5. The automobile of claim 1, wherein the processing module is configured for:
calculating and obtaining, according to the first noise signal at each door and a first function from the first noise signal to one of the preset positions, a processed signal from the door to the preset position;
calculating and obtaining, according to each processed signal, an acoustic response of each of the sound devices, and a second function from each of the sound devices to one of the preset positions, the noise reduction signal sent from the sound devices to one of the preset positions.

6. The automobile of claim 2, wherein the processing module is configured for:
calculating and obtaining, according to the first noise signal at each door and a first function from the first noise signal to one of the preset positions, a processed signal from the door to the preset position;
calculating and obtaining, according to each processed signal, an acoustic response of each of the sound devices, and a second function from each of the sound devices to one of the preset positions, the noise reduction signal sent from the sound devices to one of the preset positions.

7. The automobile of claim 5, wherein the first function and the second function are both acoustic transmission functions related to frequency, amplitude, phase, and delay time.

8. The automobile of claim 1, wherein four doors and four sound collecting devices are provided; one sound collecting device is arranged at one door; the seat comprises a seat body and a headrest; one headrest is provided with two sound devices at an interval; the automobile body inside has two preset positions spaced from the headrest; the processor generates, on the basis of the four first noise signals, one noise reduction signal transmitted to each of the sound devices; and each of the sound devices is configured for sending, according to the noise reduction signal, the sound signal to the two preset positions to offset eight second noise signals transmitted from each door to the two preset positions.

9. The automobile of claim 2, wherein four doors and four sound collecting devices are provided; one sound collecting device is arranged at one door; the seat comprises a seat body and a headrest; one headrest is provided with two sound devices at an interval; the automobile body inside has two preset positions spaced from the headrest; the processor generates, on the basis of the four first noise signals, one noise reduction signal transmitted to each of the sound devices; and each of the sound devices is configured for sending, according to the noise reduction signal, the sound signal to the two preset positions to offset eight second noise signals transmitted from each door to the two preset positions.

10. The automobile of claim 1, wherein the sound collecting devices are electret microphones or micro microphones; and the sound devices are moving-coil type, piezoelectric type or electrostatic mini speakers.

11. A noise reduction method for an automobile, wherein the automobile comprises an automobile body having an accommodating space and a plurality of doorways communicating therewith, at least one seat mounted in the accommodating space, and a door connected with the automobile body and configured for closing each doorway, wherein the automobile body inside has at least two preset positions spaced from the seat; and the noise reduction method comprises:
acquiring a first noise signal which is collected by a sound collecting device arranged on the automobile body at a periphery of each door and corresponds to the door;
processing each first noise signal to obtain a noise reduction signal transmitted to each of at least two sound devices arranged on each seat;
controlling each of the sound devices to send, according to the noise reduction signal, a sound signal to the at least two preset positions to offset all second noise signals from each door to the at least two preset positions.

12. The noise reduction method of claim 11, wherein the processing each first noise signal to obtain a noise reduction signal transmitted to each of at least two sound devices arranged on each seat comprises:
calculating and obtaining, according to the first noise signal at each door and a first function from the first noise signal to one of the preset positions, a processed signal from the door to each preset position; and
calculating and obtaining, according to each processed signal, an acoustic response of each of the sound devices, and a second function from each of the sound devices to one of the preset positions, the noise reduction signal sent from each of the sound devices to one of the preset positions.

13. The noise reduction method of claim 11, wherein the noise reduction signal of each preset position has a value equal to that of all the second noise signals transmitted from the door to the preset position.

14. The noise reduction method of claim 12, wherein the noise reduction signal of each preset position has a value equal to that of all the second noise signals transmitted from the door to the preset position.
